(19) United States
(12) Patent Application Publication
(10) Pub. No.: US 2025/0231728 A1
(43) Pub. Date: Jul. 17, 2025

(54) WHITEBOARD CONTENT SHARING SYSTEM

(71) Applicant: Adam Crappel, Morgan City, LA (US)

(72) Inventor: Adam Crappel, Morgan City, LA (US)

(21) Appl. No.: 19/090,654

(22) Filed: Mar. 26, 2025

Related U.S. Application Data
(63) Continuation-in-part of application No. 18/202,931, filed on May 28, 2023.

(51) Int. Cl. G06F 3/14; H04N 21/462; H04N 21/478

(52) U.S. Cl. CPC G06F 3/1454; H04N 21/462; H04N 21/478

(57) ABSTRACT

A multi-media whiteboard system that operates to display content maintained in non-volatile computer readable memory, and that operates under a first users control to save whiteboard content to a remote file server which assigns key information to the content and to transmit the content associated with the key to a second user if it receives a file request message from the second user that has the key information.

### FIELD OF THE INVENTION

The present disclosure relates to a system for performing smart, interactive whiteboard functionality and displaying television content.

### BACKGROUND

Smart, interactive whiteboard systems are commercially available that operate to allow a user to interact with content displayed on a whiteboard screen. The screen comprising the whiteboard system can be touch sensitive, the system can be connected to external computational devices (wired or wireless) and/or a network, and the system typically has different types of content that can be selected by a user for display on the screen. Once displayed by the system, the user can interact with the content to, for example, alter the manner in which it is displayed, change the displayed content or to edit the content, or to select the displayed content to display other, meta-content. While a smart, interactive whiteboard system (whiteboard) can be employed to display many different types of content, such whiteboards are frequently utilized to display educational or instructional content in a classroom setting. In the case that educational content is selected for display, an instructor/user may then be able to select particular content associated with a lesson or portion of a lesson for display by touching the screen proximate to indexed content they wish to select. Interacting with the content on the screen can have the effect of displaying metadata corresponding to the selected content. Further, the educational content can be edited or modified by the user interacting with content displayed on the whiteboard, such as deleting and adding new content as needed to respond to student questions or comments.

The content displayed on an interactive whiteboard screen can be maintained in memory comprising the whiteboard, or it can be content received from an external computational or communication device. Regardless, once the content is displayed on the whiteboard screen, a user is then able to interact with the content as described above. Typically, a whiteboard system is advantageously used in an environment in which is it beneficial for a user to interact with the whiteboard content while standing proximate to the whiteboard.

### BRIEF DESCRIPTION OF THE DRAWINGS

FIGS. 1A, 1B, and 1C are drawings illustrating a whiteboard screen 100 having content associated with a whiteboard mode of operation.

FIGS. 2A-2D are drawings of the whiteboard screen 100 having content associated with a TV mode of operation.

FIG. 3 is a diagram showing a logical flow that can be implemented to control the operation of a smart, interactive whiteboard system 400.

FIG. 4A is a diagram showing functional blocks comprising one embodiment of the whiteboard system 400.

FIG. 4B is a diagram showing functional blocks comprising another embodiment of the whiteboard system 400.

FIG. 5 is a diagram showing functional blocks comprising a motherboard 401 in the whiteboard system 400.

FIG. 6 is a diagram illustrating a network 605 supporting communication between a plurality of whiteboards and at least one WB file server 620.

FIG. 7 is a block diagram illustration functionality comprising an embodiment supporting file retrieval.

FIGS. 8A and 8B are block diagram showing functionality comprising whiteboard file save 480A functionality and whiteboard file retrieve 480B functionality respectively.

FIG. 9 is a diagram illustration functional blocks comprising a server 620 that operates to maintain and to download whiteboard files.

### DETAILED DESCRIPTION

Currently available smart, interactive whiteboard systems tend to be single purpose systems, only incorporating functionality that permits a user to display and interact with the displayed content while being proximate to the system. However, interactive whiteboards are now in use that can operate to accept external content that a user is not able to interact with, such as video content. This interactive or non-interactive content is typically maintained in storage associated with the whiteboard system, on an external computational device connected to the whiteboard system, or downloaded from a network.

While smart, interactive whiteboard systems are easy to operate and work well to facilitate presentations of various types, they are not well suited to displaying content that is broadcast over-the-air or over a cable medium, such as television content.

According to one embodiment, in order to expand the usefulness of a smart, interactive whiteboard system, I have designed a multi-media whiteboard system with functionality that permits it to display content that a user can interact with and to receive and display a television signal from either an over-the-air (OTA) or cable television source.

According to another embodiment, a smart, interactive whiteboard system can be configured to block access to television content, pending the successful completion of one or more tasks by a user (i.e., non-privileged user). Such task or tasks can comprise one or more steps displayed by the system as interactive content, and each one of the steps in a task must be completed successfully prior to the whiteboard system allowing the non-privileged user to gain access to and display TV content. Further, each task can be designed to be more or less difficult. Alternatively, access to television programming content can be restricted to a greater or lesser degree depending upon what type of task, how many task steps or how many tasks are successfully completed.

According to another embodiment, restricted access to television content is permitted if only one of the plurality of the tasks is completed successfully.

According to another embodiment, upon completion of all of the one or more tasks by the non-privileged user, the smart, whiteboard system can be controlled to display an access code that the non-privileged user can enter into the system. Once entered into the system, the non-privileged user is allowed to control the smart, interactive whiteboard system to enter into a television mode of operation.

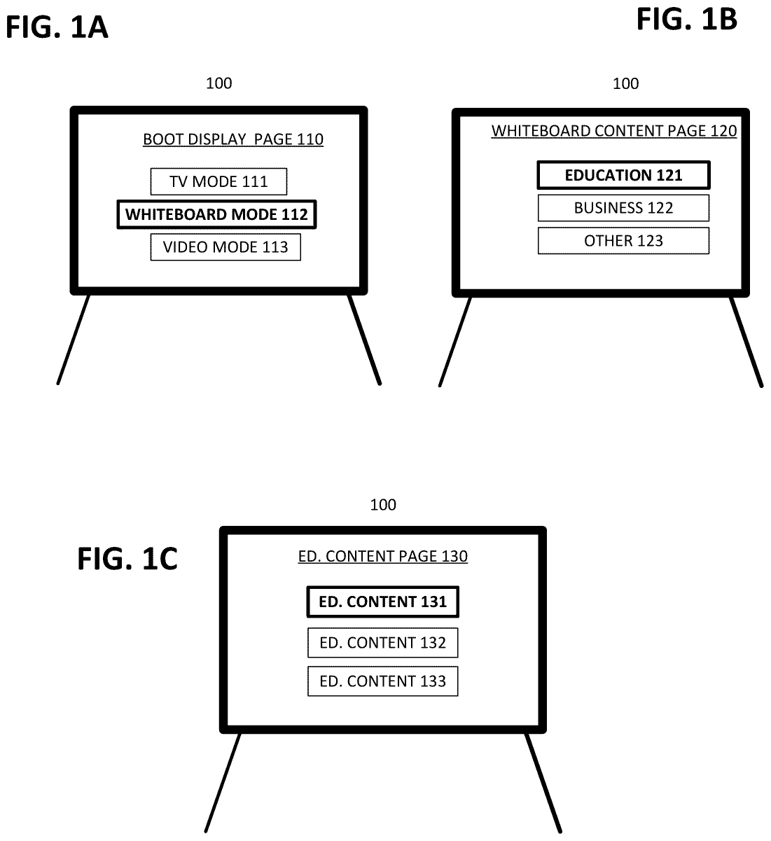

These and other embodiments will now be described with reference to the figures, in which FIGS. 1A, 1B and 1C show three smart, interactive whiteboard screens 100 each displaying different interactive content, hereinafter referred to a simply content. FIG. 1A shows a screen 100 displaying a page 110 that a whiteboard system 400 can access from memory at the time the system is turned on/initiated. Page 110 displays three different modes of operation that a user can select to run the system. The whiteboard system is not limited to three modes of operation, but for the purpose of this description page 110 shows a TV mode 111, a whiteboard mode 112, and a video mode 113. A user is permitted to interact with the screen to select any of the operational modes displayed, but in this case FIG. 1A shows that a user has selected (illustrated in bold) the Whiteboard Mode 112. Once selected, in FIG. 1B the system displays the types of content available on the page 120, which in this case is educational type content 121, business type content 122, or some other type of content 123. Assuming that the user selects the educational content 121, the system then displays, shown in FIG. 1C, the educational page 130 having, in this case, three different types of educational content 131, 132 and 133 that are available to the user for selection.

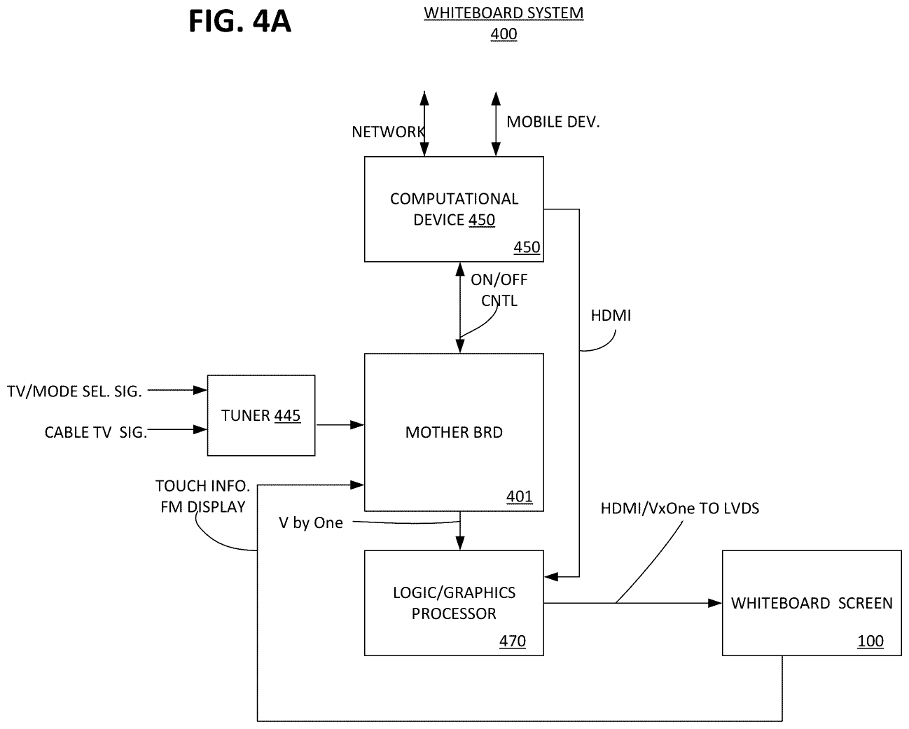

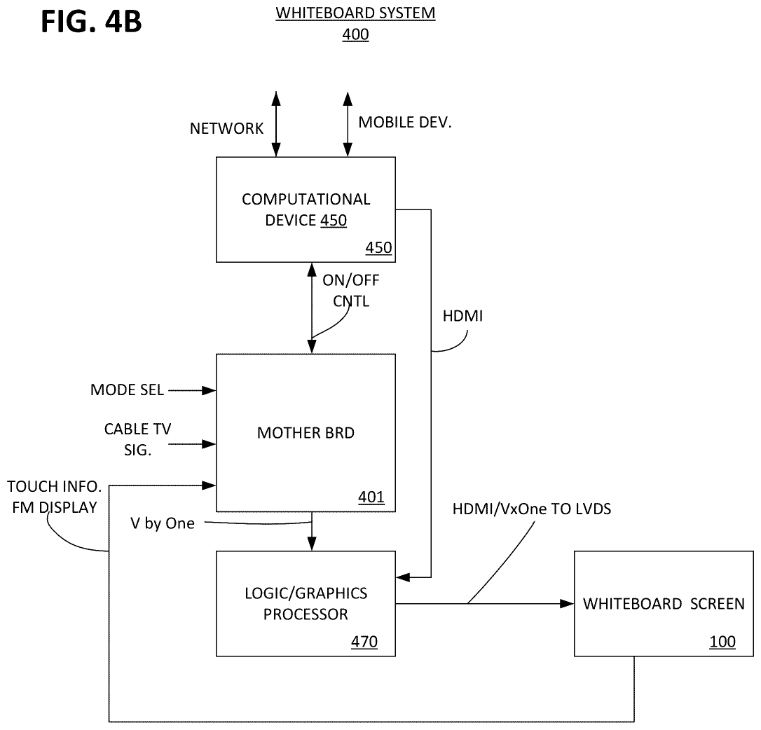

As will be describe in more detail later with reference to FIG. 4, the smart, interactive whiteboard system 400 comprises a screen 100 that when touched, or when it detects the proximity of a hand, allows a user to control the operation of the system 400 and to interact with content displayed on the screen. Such a touch sensitive screen can be implemented using either LCD or LED technology, and can be a capacitive touch screen, resistive touch screen or proximity sensitive touch screen (typically implemented using LED screen technology). For the purpose of this description, the smart, interactive whiteboard system 400 will be referred to herein-after as simply a whiteboard system 400 or system 400 and the touch-sensitive screen will be referred to as a whiteboard screen or simply a screen.

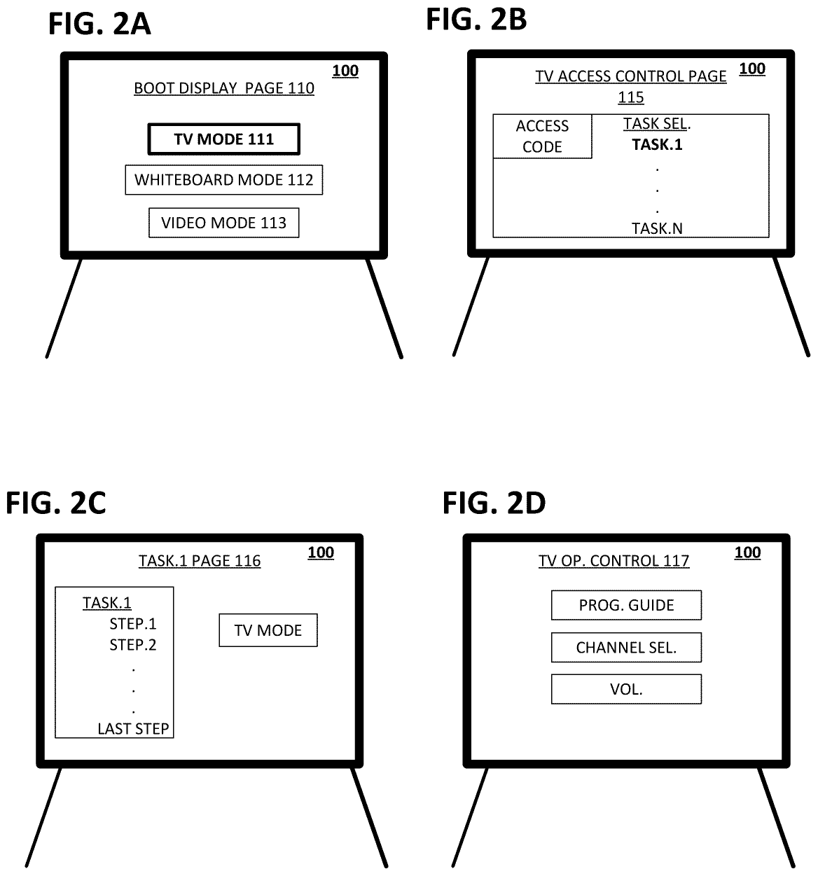

Turning now to FIGS. 2A-2D. FIG. 2A is an illustration showing the whiteboard system screen 100 displaying information corresponding to three different modes of operation, namely the TV mode 111, the whiteboard mode 112 and the video mode 113. In this case, FIG. 2A shows that a user has selected the TV mode (illustrated in bold), and this selection controls the system 400 to display, as shown in FIG. 2B, a TV access control page 115 on the screen 100. This page is comprised of one or more tasks, Task.1 to Task.N, that are available for selection by a user, and it has a field on the screen into which can be entered an access code if known. Assuming that the access code is not known, then the user has to select and complete one or more tasks in order to be permitted access to television programming content. If, in FIG. 2B, the user selects the task, Task.1, then the system displays, as shown in FIG. 2C, one or more steps associated with this task on the screen, and each step is comprised of content that the user can interact with in order to complete the task. If the user is able to successfully complete each step in the selected task, then subsequent to successfully completing the last step, the system can either require the user to manually control the system to transition to the TV mode (as shown in FIG. 2D), or the system can automatically transition to the TV mode of operation and display a TV operational control page 117 having control fields that when selected cause the system to display a program guide, display channel selection or volume control.

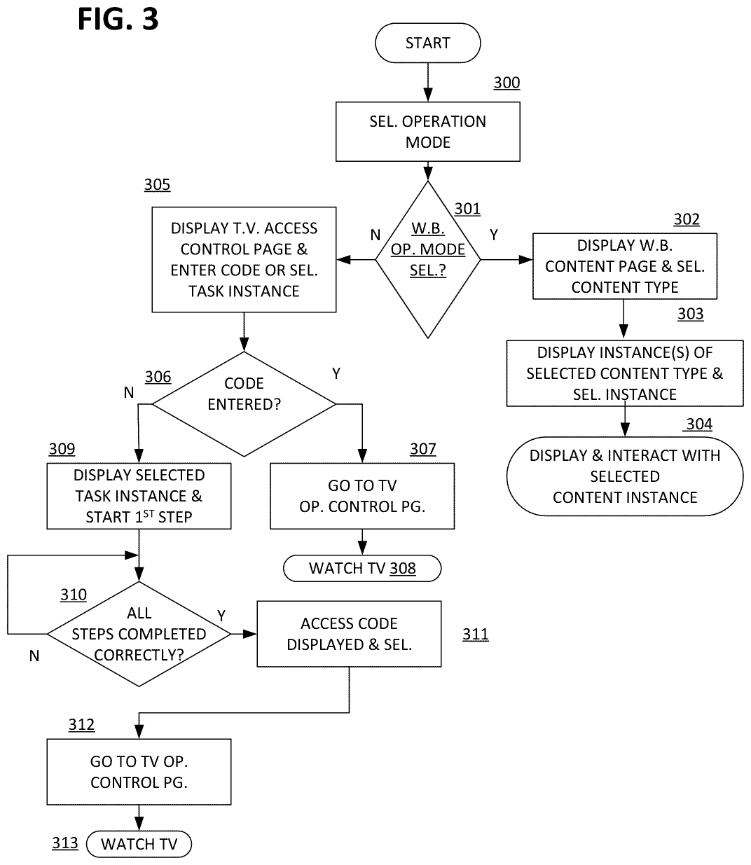

The operation of the whiteboard system 400 can be controlled by logical computer instructions maintained in any suitable non-volatile computer memory that can be accessed by a processor. Such logical instructions are shown with reference to the flow chart in FIG. 3. When the system 400 is turned on/booted up, at 300 the logic controls the system to display information associated with a plurality of system operational modes. These operational modes can include, but are not limited to, a TV mode, a whiteboard mode or other modes. If at 301 a user interacts with the displayed content to select the whiteboard mode, then the process proceeds to 302 where the system is controlled to display different types of content from which a user can select, such as content associated with an education instructional material, or content associated with a business marketing presentation or some other type of content. Once the user selects a type of content, the system is controlled to go to 303 where one or more different instances of the selected content type are displayed. If the education instructional content was selected at 302, then an instance of instructional content can be selected, such as a mathematics lesson, or a history lesson, or any other type of content associated with an educational process. At 304, the selected instance of instructional content is displayed for the user to interact with.

Referring back to 301 in FIG. 3, if at this point the user selected the TV mode of operation, then the system 400 is controlled at 305 to display one or more instances of tasks to be complete before access to TV programming is permitted, and to display a field on the system screen into which a valid access code can be entered. If the user knows a valid access code, then the code can be entered into the system, and if the system recognizes the code at 306 the process can proceed to 307 where the system can activate the TV programming in order to watch TV at 308. On the other hand, if at 305 the user does not know a valid access code, then they can select one of the displayed tasks to complete, and at 306 the system determines that a code has not been entered, and the process proceeds to 309 where the system displays the selected task. Once content associated with the selected task is displayed at 309, the user can start interacting with the content to complete the task. At 310, when the system determines that all steps comprising the selected task have been complete successfully, the process proceeds to 311 where a TV access field can be displayed and selected by the user. Selecting the TV access field controls the system to activate the TV mode of operation, and at 313 permits the user to watch a selected TV program.

Turning now to FIG. 4A, which is a diagram showing functional blocks comprising a whiteboard system 400 described in part earlier with reference to FIGS. 1A-1C, 2A-2D, and FIG. 3. The whiteboard system 400 can be comprised of, among other things, a mother board 401, a computational device 450, a graphics processor 470, a TV tuner 445, and a touch sensitive screen 100 that together operate to perform various whiteboard functions, and to control the display of TV programming. The mother board 401 is connected to the display 100 from which it receives information generated by a user touching content displayed at different locations on the screen. The mother board is connected to a network (LAN or WAN) over which it can receive information from an internet service provider, and it is also connected to the TV tuner that can operate to receive TV signals. Associated with the TV tuner are one or more buttons (touch or push type), that a user can use to control TV programming content and a system loud speaker volume, for example. The mother board is also connected to a computational device 450, which can receive information comprising audio and/or video content from an external device (any computer or mobile device) and send this content to graphics processor 470. Further, the mother board operates to receive a cable TV signal from the tuner, and to reformat the TV signal to a V by One signal and send this signal to the graphics processor 470. The whiteboard display 100, can be comprised of a screen with the necessary electronic components to receive image type signals from the graphics processor or to send touch information to the mother board 401. The display 100 can be implemented in any type of technology that is capable of detecting a user's touch on a particular area of the screen (i.e., LED or LCD screen). The computational device 450 can be any device with the capability of connecting to and processing information generated by several different types of media devices, such as an Internet signal, video or any other type of multi-media signal. And the graphics processor 470 can be any device capable of receiving an HDMI or “V by One” type signal and converting it into a signal format that can be displayed on the whiteboard display 100, such as an LVDS signal.

Continuing to refer to FIG. 4A, in operation the system 400 can be controlled by a user to enter into a number of different modes for which the system is configured. Two of these modes can be the whiteboard and the TV modes of operation. In the case that the TV mode is selected, a TV signal tuner device connected to the mother board 401 is activated, and can be controlled by the user to select a particular TV channel signal which it receives from a cable TV network connection or an over the air TV signal. The tuner demodulates the cable TV signal and sends it to the mother board which can convert the signal to V by One format before sending it to the graphics processor which converts the signal to an LVDS signal for display.

Referring now to FIG. 4B, which is a diagram that illustrates functionality comprising the same whiteboard system 400 describe with reference to FIG. 4A, but having the tuner 445 incorporated into the mother board 401.

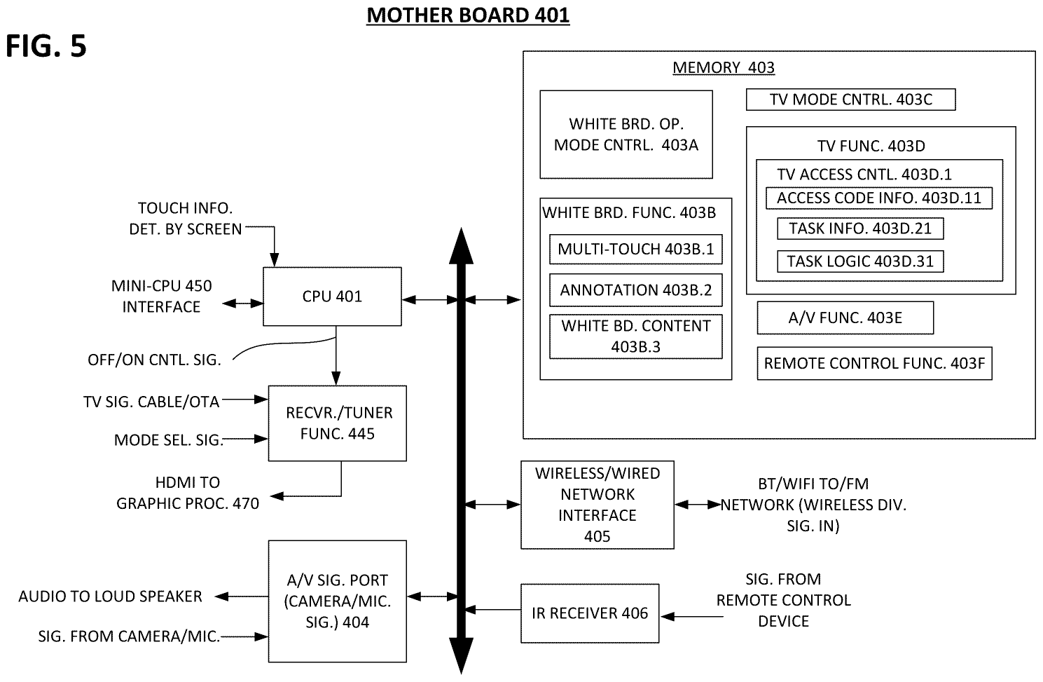

Turning now to FIG. 5, which is a diagram illustrating functional blocks comprising the mother board 401 implemented on the system 400. According to the embodiment in FIG. 5, the mother board has a central processing unit (CPU) 401, the TV signal receiver/tuner 445, non-volatile memory 403, a video/audio signal port 404, a network interface 405, and an infrared (IR) receiver 406. The CPU 401 generally operates to control functionality associated with the whiteboard and the functionality associated with access to the TV programming, much of which is maintained as computer software/firmware instructions in the memory 403. More specifically, the TV tuner 445 can receive (or generate) mode select signal information from either the mode-select buttons implemented on the whiteboard or from mode select content displayed on the whiteboard screen and selected by a user. The mode select signal is used to control access to either the whiteboard functionality 403A or the TV functionality 403C maintained in the memory 403. The CPU 401 also controls the operational state of the tuner 445 to either process, or not process, an incoming cable TV signal. If the tuner is controlled to process the TV signal, then the TV signal (HDMI) is sent to the graphics processor 470 in the form of a V by One signal.

Continuing to refer to FIG. 5, the memory 403 can be implemented in any appropriate non-volatile computer memory that is accessible to the CPU 401. The memory 403 has logical software/firmware instructions 403A and 403C that the CPU can use to control the system 400 to enter into either the whiteboard mode or the TV mode of operation respectively. The memory also maintains instructions that control the operation of whiteboard multi-touch functionality 403B.1, annotation functionality 403B.2, and whiteboard content information 403B.3, all of which are maintained in the memory 403 as whiteboard functionality 403B.

The operation of the multi-touch functionality 403B.1 and the annotation functionality 403B.2 are well understood by those knowledgeable in the area of whiteboard design, and so won't be described here in any detail. The whiteboard content 403B.3 is comprised of a plurality of instances of content as described earlier with reference to FIGS. 1A-1C and 2A-2D, and so won't be described again here.

Continuing to refer to FIG. 5, the memory 403 also has TV mode control instructions 403C that can be used by the CPU in order to display TV access control information 403D.1. This access control information is comprised of, among other things, a field displayed on the whiteboard screen into which an access code can be entered (if known) by a privileged user, and is comprised of a listing of tasks 403D.21 any one or more of which can be selected for completion by a user (if the user does not know the access code) in order to be gain access to TV programming. The access code information 403D.11 can be determined by an administrator and the system 400 can be configured accordingly. The memory is also comprised of task logic 403D.31 that controls the operation of the system to allow a user to work on a selected task. 33. Continuing to refer to FIG. 5, the memory 403 also comprises audio/video processing functionality 403E, and functionality 403F to process signals (i.e., IR signals) received via an IR receiver 406 from a remote device in order to control the whiteboard operation. The A/V functionality can operate to process information received via a port 404 from a camera or microphone, and to send an audio signal to a whiteboard loud speaker (not shown).

According to another embodiment, a white board, such as the one described with reference to FIG. 4A, can have additional functionality that allows a user to easily save and retrieve WB screen content/information to and from a remote server respectively. According to this embodiment, a first user can control a first WB to save a file to a remote server which creates an associated “key” and returns the key to the first user. The first user can share the key with a second user operating a second WB, and the second user can retrieve the file stored by the first user on the remote server by merely entering the key information into a file retrieval/download application.

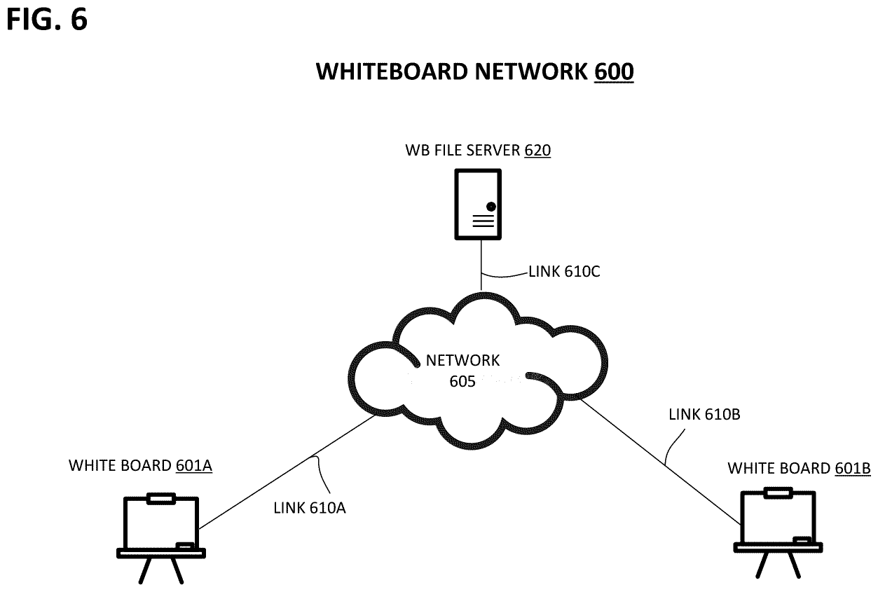

FIG. 6 is an illustration of a network 600 showing a first white board 601A, a second white board 601B, and a WE file server 620, each of which can be connected to one another over a local (LAN) or wide area network (WAN) 605 over links 610A, 610B and 610C.

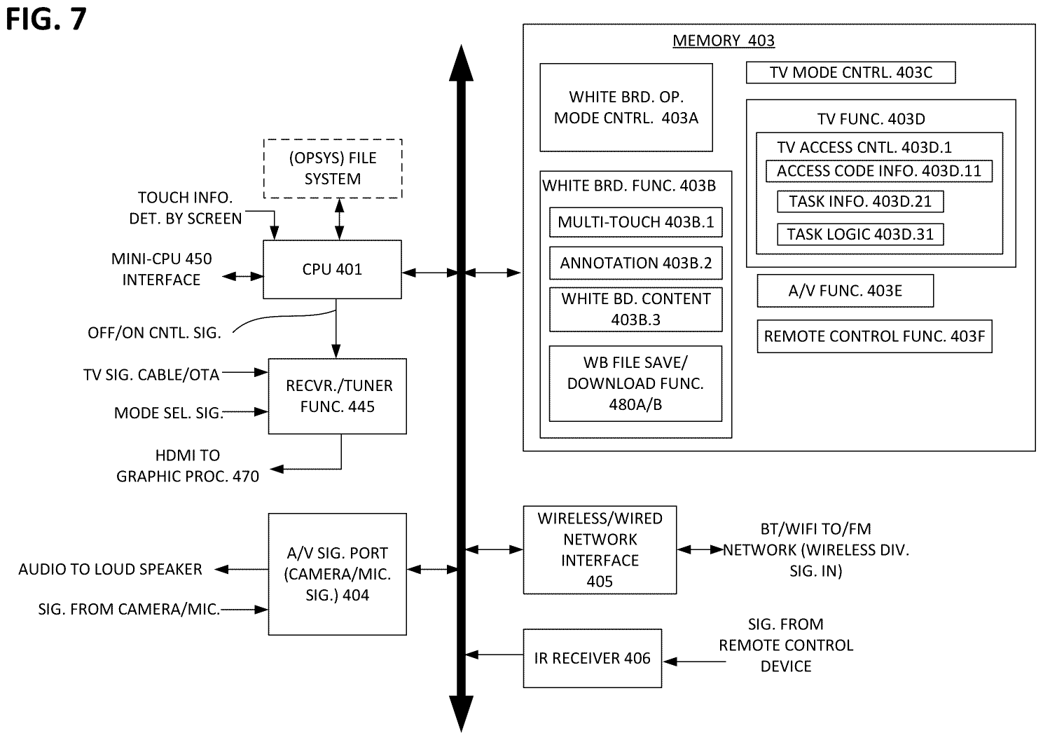

FIG. 7 is a high-level block diagram illustrating functionality (WB file save/download func. 480A/B) that can be employed to implement this additional file save and retrieve operation. With the exception of the functionality in block 480A/B, the mother board in FIG. 7 is substantially similar to the mother board 401 functionality described earlier with reference to FIG. 5.

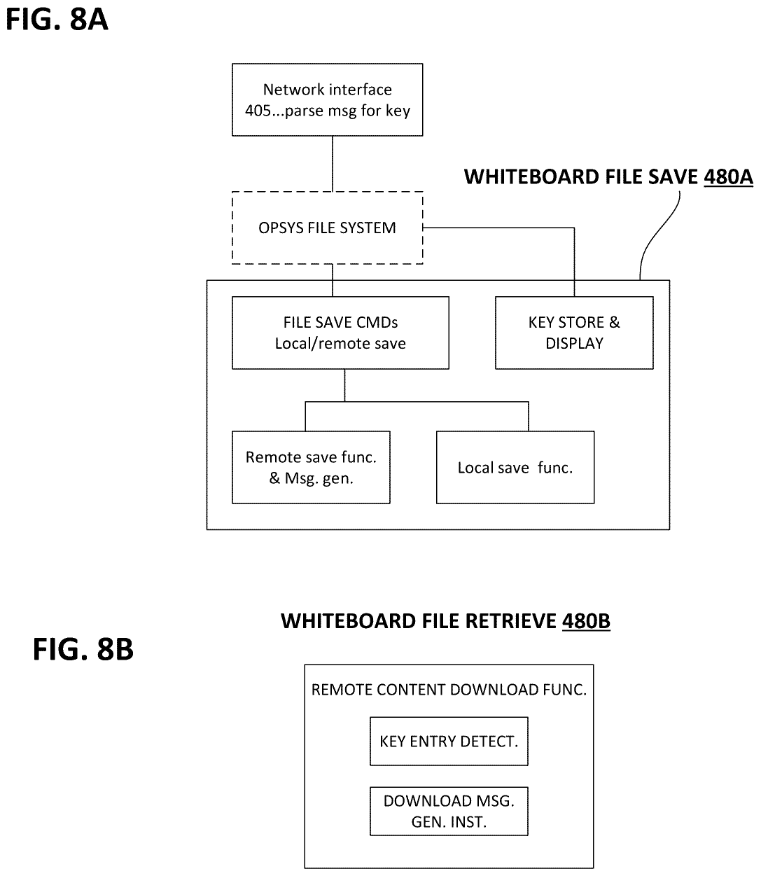

FIG. 8A is a block diagram showing the WB file save functionality 480A, OPSYS File System functionality and a network interface 405. In operation the first user can enter a command into a WB system (such as the system 400 described with reference to FIG. 4A) to initiate a process that causes the operating system (file system) to at least temporarily store content currently displayed on the first WB screen in either non-volatile or volatile memory. The first user can then select the file save function 480A which operates to generate and transmit, to the remote file server 620, a message comprised of the remote file server network address, a network identity of the first WB, and the selected/stored WB screen content.

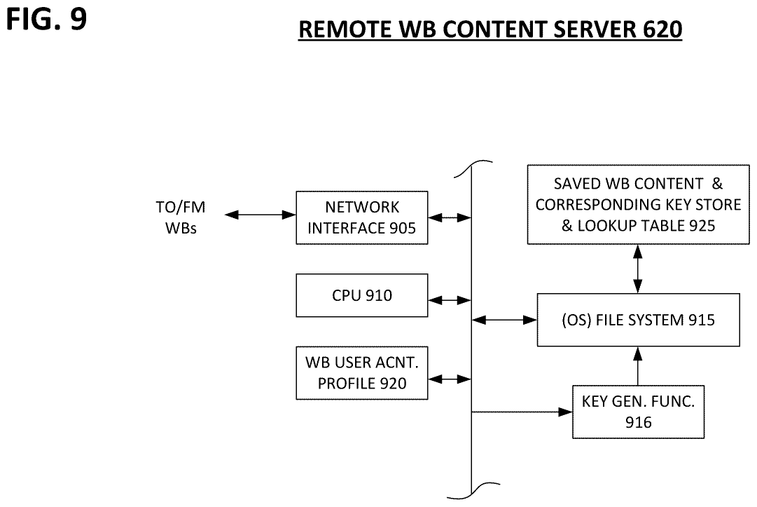

The remote server 620 (describe later with reference to FIG. 9) receives the file save message and generates an associated “Key” that is sent back to the first WB. The first WB receives the “Key” and the network interface 405 parses the message for the “Key” (and any other information needed) and the OPSYS file system can either store the Key or it can be displayed on the first WB screen.

FIG. 8B is a block diagram illustrating functionality 480B that operates to allow a user of a second WB system to retrieve the file saved earlier by the user of the first WB system. The functionality 480B is comprised of file Key detection module 485 and a download message generation module 486. In operation, the first user (who created and saved the file to the server) can notify a second user of the Key information associated with the file they saved and would like to share. The second WB user enters the Key information into the WB file download function 480B, and the module 485 detects the Key, which is used by a download message generation module 486 to generate a file request message (with the Key) that is transmitted to the remote server 620. As previously described, the remote server detects the Key and returns a file associated with the Key to the second user for display (or storage) by the second users WB.

FIG. 9 is a block diagram illustrating functionality comprising the remote server 620, that operates to maintain WB files in association with Key information it generates, and to download WB files in response to receiving a Key in a file retrieve message. A Key can be comprised of a plurality of characters, and the characters can be letters, numbers, or special characters or any combination thereof. The server 620 can be comprised of a network interface 905, a CPU 910, a file system 915, WB user account information 920, Key generation functionality 916, and memory 925 having a lookup table generated by the file system.

In operation the server 900 can receive a file from a WB user (i.e., a first WB user) store the file in the memory 925 and assign a Key to the stored file which can be maintained in a lookup table (in memory 925) in association with a pointer to the file with which it is associated. The WB user account profile 920 is comprised of information relating to each user that is authorized to store and retrieve files to/from the server. Then, when the server receives a Key in a file request message from the second user, it uses the Key to lookup the file ID and send this file to the second user.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A whiteboard content sharing system, comprising:
first and second whiteboards, connected to a communication network, that operate under control of a computational device to display content that is maintained by the first and second whiteboards; and
a whiteboard file server, connected to the communication network, operates to maintain content received from the first and second whiteboards;
wherein a first whiteboard user controls the first whiteboard to save content that is displayed on the first whiteboard screen, and to transmit the saved content to the whiteboard file server; and
wherein the whiteboard file server receives the content, maintains the content in a file system, assigns information comprising a unique key to the file, and sends a message to the first whiteboard that has the key information assigned to the content file; and
wherein the first user informs a user of the second whiteboard of the key information, and the second user sends a content file request message to the file server that is comprised of the key information to request that the file server transmit the content file to the second whiteboard.

2. The system of claim 1, further comprising the file server transmitting the requested content file to the second whiteboard.

3. The system of claim 1, wherein the whiteboard content is multi-media content.

4. The system of claim 3, wherein the multi-media content is audio content, image content, video content, or any combination thereof.

5. The system of claim 1, wherein the whiteboard content is created by a whiteboard user or is content maintained on the whiteboard in association with a computer application.

6. The system of claim 1, wherein the information comprising the key is comprised of a plurality of numerals, characters or any combination thereof.

7. The system of claim 1, wherein the communication network is a wide area network or a local area network.

8. A method for sharing content between a plurality of multi-media whiteboard systems, comprising:
a user controlling a first whiteboard to save whiteboard screen content to a file server located remotely from the first whiteboard;
wherein the first whiteboard and the file server are connected to a common communication network;
the file server assigning key information to the saved content and sending a message to the first whiteboard having the assigned key information;
the first user informing a user of a second whiteboard of the assigned key information; and
the second user controlling the second whiteboard to transmit a content request message having the key information to the file server to transmit the saved content to the second whiteboard.

9. The method of claim 8, further comprising the file server receiving the content request message from the second whiteboard and transmitting the requested save content to the second whiteboard.

10. The method of claim 8, wherein the whiteboard content is multi-media content.

11. The method of claim 9, wherein the multi-media content is audio content, image content, video content, or any combination thereof.

12. The method of claim 8, wherein the whiteboard content is created by a whiteboard user or is content maintained on the whiteboard in association with a computer application.

13. The method of claim 9, wherein the information comprising the key is comprised of a plurality of numerals, characters or any combination thereof.

14. The method of claim 8, wherein the communication network is a wide area network or a local area network.

15. A method of operating a whiteboard, comprising:
a whiteboard, connected to a communication network, operating under control of a computational device to display interactive content maintained in non-volatile computer readable memory;
wherein a first whiteboard user controls a first whiteboard to save content displayed on the whiteboard, and to transmit the saved content to a whiteboard file server connected to the communication network that is remote from the first whiteboard;
wherein the first whiteboard receives information comprising a key from the file server that is assigned to the content saved by the first whiteboard; and
wherein the user informs a user of a second whiteboard that is connected to the communication network of the key information, and the second user sends a content file request message to the file server that is comprised of the key information to request that the file server transmit the content comprising file to the second whiteboard.

16. The method of claim 15, wherein the whiteboard content is multi-media content.

17. The method of claim 16, wherein the multi-media content is audio content, image content, video content, or any combination thereof.

18. The method of claim 15, wherein the whiteboard content is created by a whiteboard user or is content maintained on the whiteboard in association with a computer application.

19. The method of claim 15, wherein the information comprising the key is comprised of a plurality of numerals, characters or any combination thereof.

20. The method of claim 15, wherein the communication network is a wide area network or a local area network.
